(19) United States
(12) Patent Application Publication
(10) Pub. No.: US 2007/0227290 A1
(43) Pub. Date: Oct. 4, 2007

(54) Pull-to-release hand brake

(76) Inventors: Anthony Stephen Ferenc, Goodrich, MI (US); Andrew Johann Radomski, Shelby, MI (US); Jason Daniel Fewins, Travers City, MI (US)

Correspondence Address: Richard M. Mescher;Porter, Wright, Morris & Arthur, LLP, 41 South High Street, Columbus, OH, 43215, US

(21) Appl. No.: 11/398,284

(22) Filed: Apr. 4, 2006

(51) Int. Cl. G05G 1/04

(52) U.S. Cl. 74/523

(57) ABSTRACT

A hand-operated parking brake actuator includes a support bracket, a hand lever supported by the support bracket and pivotable between a brake-released position and a brake-applied position, and a pull-to-release lock mechanism operably connecting the hand lever to the support bracket. The hand lever is locked against movement towards the brake-released position when the hand lever is in the brake-released position and the hand lever is pulled a first time towards the brake-applied position and the hand lever is free to move towards the brake-released position when the hand lever is in the brake released position and is pulled a second time towards the brake-applied position.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to hand brakes for motor vehicles and, more particularly, hand brakes for motor vehicles that can be applied and released by pulling the same lever.

### BACKGROUND OF THE INVENTION

Motor vehicles are typically provided with park or “emergency” brakes that are operated by a cable. The cable extends from the brake mechanism to an actuator within the passenger compartment of the vehicle and convenient to the driver. The actuator is operated to tension and release the cable to apply and release the parking brake mechanism. The actuator can be a hand lever for hand operation. A lock mechanism is provided to retain the hand lever in a brake-apply position when the operator pivots the hand lever and a release is provided to selectively disengage the lock so that the hand lever returns to a brake-unapplied position. The release is typically in the form of a push button located at a free end of the hand lever and a rod that extends from the push button to the lock mechanism to disengage the lock mechanism when an operator actuates the push button. For examples of such hand-operated brake actuators, see U.S. Pat. Nos. 5,001,942, 5,303,610, and 6,662,676, the disclosures of which are expressly incorporated herein in their entireties by reference.

While these prior hand-operated brake actuators may adequately apply and release the motor vehicle parking brakes, they are relatively complex and inexpensive to produce, and require some dexterity on the part of the operator in order to release the lock mechanism. There is a never ending desire in the motor vehicle industry to reduce cost, weight and package space without adversely affecting performance. There is also a never ending desire to improve operability and provide more feature rich products. Accordingly, there is a need in the art for an improved hand-operated parking brake actuator for a motor vehicle.

### SUMMARY OF THE INVENTION

The present invention provides an improved hand-operated parking brake actuator which overcomes at least some of the above-noted problems of the related art. According to the present invention, a hand-operated parking brake actuator comprises, in combination, a support bracket, a hand lever supported by the support bracket and pivotable between a brake-released position and a brake-applied position, and a pull-to-release lock mechanism operably connecting the hand lever to the support bracket. The hand lever is locked against movement towards the brake-released position when the hand lever is in the brake-released position and the hand lever is pulled a first time towards the brake-applied position and the hand lever is free to move towards the brake-released position when the hand lever is in the brake released position and is pulled a second time towards the brake-applied position.

According to another aspect of the present invention, a hand-operated parking brake actuator comprises, in combination, a support bracket, a hand lever supported by the support bracket and pivotable between a brake-released position and a brake-applied position, and a pull-to-release lock mechanism operably connecting the hand lever to the support bracket. The lock mechanism includes a sector gear having a plurality of ratchet teeth, a pivotable pawl having a hook selectively engageable with the ratchet teeth to lock the lever in the brake-applied position, and a resilient spring member movable to selectively bias the pawl in opposed directions relative to sector member. The pawl is movable between an engaged and loaded position wherein the hook engages the sector member and the spring member biases the hook towards the sector member, an engaged and unloaded position wherein the hook engages at least one of the ratchet teeth and the spring member biases the hook away from the sector member, and a released and unloaded position wherein the hook is released from the sector member and the spring member biases the hook away from the sector member.

According to yet another aspect of the present invention, a hand-operated parking brake actuator comprises, in combination, a support bracket, a hand lever supported by the support bracket and pivotable between a brake-released position and a brake-applied position, and a pull-to-release lock mechanism operably connecting the hand lever to the support bracket. The lock mechanism includes a sector gear having a plurality of ratchet teeth, a pivotable pawl having a hook selectively engageable with the ratchet teeth to lock the lever in the brake-applied position, and a torsion spring acting between the pawl and the support bracket and movable to selectively bias the pawl in opposed directions relative to sector member. The pawl is rotatable about a connection pin extending through a slot in the pawl. The pawl is movable between an engaged and loaded position wherein the hook engages the sector member and the spring member biases the hook towards the sector member, an engaged and unloaded position wherein the hook engages at least one of the ratchet teeth and the spring member biases the hook away from the sector member, and a released and unloaded position wherein the hook is released from the sector member and the spring member biases the hook away from the sector member. The pawl is in the engaged and loaded position when the hand lever is in the brake-released position, the pawl is moved to the engaged and unloaded position and the hand lever is locked against movement towards the brake-released position when the hand lever is pulled a first time towards the brake-applied position and released, and the pawl is moved to the released and unloaded position and the hand lever is free to move towards the brake-released position when the hand lever is in the brake released position and is pulled a second time towards the brake-applied position.

From the foregoing disclosure and the following more detailed description of various preferred embodiments it will be apparent to those skilled in the art that the present invention provides a significant advance in the technology and art of hand-operated parking brake actuators. Particularly significant in this regard is the potential the invention affords for providing a high quality, reliable, low cost parking brake actuator which is relatively easy to operate. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a side perspective view of a hand-operated parking brake actuator according to a preferred embodiment of the present invention, wherein portions of components are removed for clarity;

FIG. 2 is a side elevation view of a pull-to-release lock mechanism of the hand-operated parking brake actuator of FIG. 1, wherein the actuator is in a brake-unapplied condition with a pawl loaded and ready to engage a sector to lock the actuator in a brake-applied condition upon movement of a hand lever and wherein portions of components are removed for clarity;

FIG. 3 is a side elevation view of the pull-to-release lock mechanism of FIG. 2, but wherein the actuator is in a brake-applied condition with the pawl unloaded and ready to release the sector to unlock the actuator from the brake-applied condition upon further movement of the hand lever in the same direction; and

FIG. 4 is a side elevational view of the pull-to-release lock mechanism of the hand-operated parking brake actuator of FIGS. 2 and 3, but wherein the pawl is rotated to a released position upon further movement of the hand lever in the same direction and the actuator is free to rotate back to the brake-unapplied condition of FIG. 2.

It should be understood that the appended drawings are not necessarily to scale, presenting a somewhat simplified representation of various preferred features illustrative of the basic principles of the invention. The specific design features of the hand-operated parking brake actuator as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the parking brake actuator illustrated in the drawings. In general, up or upward generally refers to an upward direction within the plane of the paper in FIG. 1 and down or downward generally refers to a downward direction within the plane of the paper in FIG. 1. Also in general, fore or forward refers to a direction toward the front of the motor vehicle, that is, generally toward the right in FIG. 1 and aft or rearward refers to a direction toward the rear of the motor vehicle, that is, generally toward the left in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved hand-operated parking brake actuators disclosed herein. The following detailed discussion of various alternative and preferred embodiments will illustrate the general principles of the invention with reference to a hand-operated parking brake actuator for a motor vehicle such as an automobile, sport utility vehicle (SUV), crossover vehicle, or the like. Other embodiments suitable for other applications will be apparent to those skilled in the art given the benefit of this disclosure.

Referring now to the drawings, FIGS. 1 to 4 show a pull-to release parking brake actuator 10 according to a preferred embodiment of the present invention. The illustrated parking brake actuator 10 includes a mounting or support bracket 12, a hand lever 14 supported by the support bracket 12 and pivotable between a brake-unapplied or brake-released position and brake-applied positions, a control cable 16 operably connecting the hand lever 14 and tensioned and untensioned by the pivoting motion of the hand lever 14 to apply and release a wheel brake mechanism upon pivoting motion of the hand lever 14, and a pull-to-release lock mechanism 18 for selectively securing the hand lever 14 in its brake-applied position.

The support bracket 12 is secured to a vehicle support structure 20 adjacent the driver's position in the motor vehicle. The illustrated hand lever 14 is pivotably connected to the support bracket 12 for pivoting motion between the brake-release positions and the brake-applied positions about a laterally-extending horizontal pivot axis 22. The free end of the illustrated hand lever 14 is provided with a gripping portion 24 so that the operator can comfortably grasp the free end of the hand lever 14 and pull upwardly and rearwardly to pivot the hand lever 14 about the pivot axis 22 from its brake-released position to a brake-applied position.

One end of the control cable 16 is connected to the hand lever 14 and the other end of the control cable 16 is operably connected to the wheel brake mechanism. When the driver pulls the grasping portion 24 to pivot the hand lever 14 in the counterclockwise direction (as shown in FIGS. 1 to 4) to the brake-applied position, the control cable 16 is tensioned to activate or set the wheel brake mechanism. The hand lever 14 is resiliently urged or biased to rotate in the clockwise direction (as shown in FIGS. 1 to 4) to the brake-released position by a return spring and/or the brake mechanism to untension the control cable 16 and deactivate or release the wheel brake mechanism. Rotation of the hand lever 14 in the clockwise direction is restricted by engagement against an abutment 26 of the support bracket 12.

The illustrated pull-to-release lock mechanism 18 includes a sector or ratchet member 28 having a plurality of ratchet teeth 30 secured to the handle arm 14 for pivotable movement therewith and a pivoting pawl 32 secured to the support bracket 12 and having a hook or engagement tooth 34 that is selectively engageable with the ratchet teeth 30. The ratchet teeth 30 and the hook 34 are sized and shaped so that when the hook 34 is engaging the sector member 28, the sector member 28 can rotate in the direction toward the brake-applied position (counterclockwise in FIGS. 1 to 4) in a ratchet like manner but cannot rotate toward the brake-released position (clockwise in FIGS. 1 to 4) to hold the hand lever 14 and the wheel brake mechanism at a position achieved when the hand lever 14 is rotated and released to activate the wheel brake mechanism.

The sector member 28 is rigidly secured to the hand lever 14 to prevent relative motion therebetween so that the sector member 28 is rotated about the lever pivot axis 22 pivoting of the hand lever 14 about the lever pivot axis 22. The illustrated sector member 28 is secured to the hand lever 14 by mechanical fasteners but can alternatively be formed as a unitary one piece component therewith. The illustrated ratchet teeth 30 are formed along a circular arc disposed about the lever pivot axis 22.

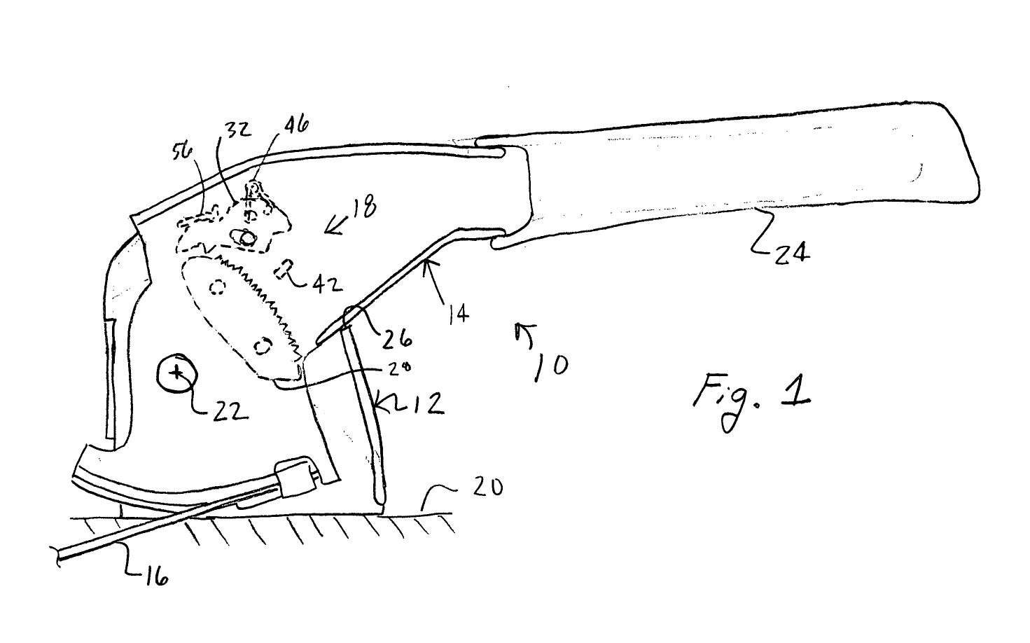

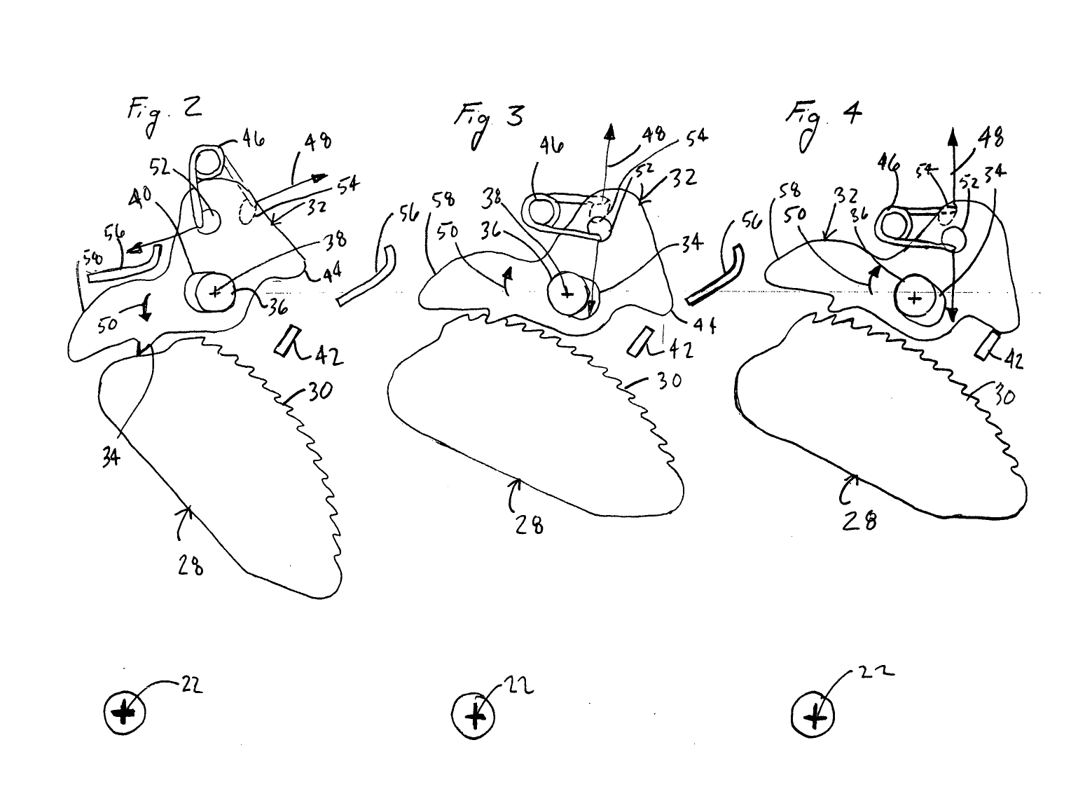

The pawl 32 is rotatably supported by the support bracket 12 about a connection pin 36 forming a laterally-extending horizontal rotational axis 38 substantially perpendicular to the lever pivot axis 22. The pawl 32 is provided with an elongated hole or slot 40 for passage of the connection pin 36. The illustrated slot is generally elongated in the direction of rotation of the hand lever 14. The pawl 32 is rotatable about the rotational axis 38 between a first or engaged position wherein the hook 34 of the pawl 32 is engaged with the sector member 28 (shown in FIGS. 2 and 3) and a second or released position wherein the hook 34 of the pawl 32 is not engaging, that is disengaged from, the sector member 52 (shown in FIG. 4). Rotation of the pawl 32 toward the released position is limited by engagement with a stop 42 secured to the support bracket 12. The illustrated pawl 32 is provided with a forwardly extending nose 44 that engages the stop 42. The illustrated nose 44 is provided on a side of the pawl 32 opposite the hook 34 so that the slot 40 is located therebetween. It is noted that rotation of the pawl 32 toward the engaged position is limited by engagement with the sector member 28.

The pawl 32 is also movable between a first or loaded position wherein the hook 34 is biased toward engagement with the sector member 28 and a second position or unloaded position wherein the hook 34 is biased toward disengagement with the sector member 28. A resilient spring member 46 extends between the support bracket 12 and the pawl 32 to selectively bias the pawl 32 in the two directions. As the pawl 32 shifts or slides along the slot 40, a force vector 48 of the spring member 46 moves to change the bias direction 50 of the pawl 32. When the pin 36 is at one end of the slot 40 (the right end in FIGS. 2 to 4), the spring force vector 48 biases the pawl hook 24 toward the sector member 28 about the rotational axis 38 (the counterclockwise direction in FIGS. 1 to 4). When the pin 36 is at the other end of the slot 40 (the left end in FIGS. 2 to 4), the force vector 48 biases the pawl 58 away from the sector member 52 about the rotational axis 38 (the clockwise direction in FIGS. 2 to 4).

The illustrated spring member 45 is a torsion spring having a first end engaging an opening 52 in the pawl 32and a second end engaging a stationary opening 54 in the support bracket 12. It is noted that the spring member 45 can alternatively be any other suitable type of resilient spring.

The illustrated hand lever 14 is provided with a pawl reset 56 that cooperates with a camming surface 58 of the pawl 32 to move the pawl 32 from the unloaded position to the loaded position upon movement of the hand lever 14 from the brake applied-position to the brake-unapplied position. The illustrated camming surface 58 is provided on a rear side of the pawl 32. It is noted that the pawl reset 56 and the camming surface 58 can be of any suitable size and shape.

When the hand lever 14 is in the brake-release position (shown in FIG. 2) and the driver upwardly pulls the hand lever 14 to active the wheel brake mechanism, the hand lever 14 rotates about the pivot axis 22 to tension the control cable 16 and activate the brake mechanism (Shown in FIG. 2). The hand lever 14 also rotates the sector member ratchet teeth 30 along the pawl hook 34 in a ratchet like manner as the pawl 32 is in the loaded and engaged positions with the spring member 46 resiliently urging the pawl hook 34 into engagement with the sector member 28. When the driver releases the hand lever 14, the pawl 58 shifts from the loaded position (shown in FIG. 2) to the unloaded position (shown in FIG. 3) by the reaction force transmitted to the hand lever 54 from the wheel brake mechanism through the control cable 16. When the pawl 32 moves to the unloaded position, the orientation or posture of the spring member 46 is changed so that the spring force vector 48 biases the pawl 32 away from the sector member 28. The handle lever 14 is retained in the brake-applied position due to the frictional engagement between the pawl hook 34 and one of the sector member ratchet teeth 30. When the driver desires to release or deactivate the wheel brake mechanism, the driver upwardly pulls the hand lever 14 in the same direction a second time (the counterclockwise direction in FIGS. 1 to 4) and the spring member 46 rotates the pawl 58 from the engaged position (shown in FIG. 3) to the released position (shown in FIG. 4) so that the pawl hook 34 moves away from the ratchet teeth 30 as the handle arm 14 pivots to release the hand lever 14. When the driver releases the handle lever 14, the return spring and/or brake mechanism resiliently moves the hand lever 14 back to its brake-released position to release the brake mechanism and the pawl rest 56 moves the pawl 32 back to its loaded and engaged position (shown in FIG. 2). With the handle lever 14 in the brake-released position and the pawl 32 in its loaded and engaged position, the actuator 10 is again ready for operation as described above.

The illustrated control cable 16 is connected directly to the hand lever 14. It is noted, however, that a self adjust mechanism can be provided therebetween in a known manner. The self-adjust mechanism automatically removes any undesired slack, due to cable stretch and the like, in the control cable 16 when the hand lever 14 is in the brake-released position in order to maintain a desired tension in the control cable 16.

It is apparent from the above detailed description of preferred embodiments of the present invention, that the hand-operated parking brake actuator 10 provides a simplified, direct design with fewer parts than the prior art. The hand-operated parking brake actuator 10 is also applied and released by pulling the hand lever 14 so that the actuator 10 requires less dexterity by the operator than prior actuators having release buttons and the like.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A hand-operated parking brake actuator comprising, in combination:
a support bracket;
a hand lever supported by the support bracket and pivotable between a brake-released position and a brake-applied position; and
a pull-to-release lock mechanism operably connecting the hand lever to the support bracket so that the hand lever is locked against movement towards the brake-released position when the hand lever is in the brake-released position and the hand lever is pulled a first time towards the brake-applied position and the hand lever is free to move towards the brake-released position when the hand lever is in the brake released position and is pulled a second time towards the brake-applied position.

2. The hand-operated parking brake actuator according to claim 1, wherein the pull-to-release lock mechanism is a ratchet mechanism.

3. The hand-operated parking brake actuator according to claim 1, wherein the pull-to-release lock mechanism includes a sector gear having a plurality of ratchet teeth, a pivotable pawl having a hook selectively engageable with the ratchet teeth to lock the lever in the brake-applied position, and a resilient spring member biasing the pawl.

4. The hand-operated parking brake actuator according to claim 3, wherein the sector gear is rigidly secured to the hand lever and the pawl is rotatably secured to the support bracket.

5. The hand-operated parking brake actuator according to claim 3, wherein the pawl is rotatable about a connection pin extending through a slot in the pawl.

6. The hand-operated parking brake actuator according to claim 4, wherein the pawl is movable along the pin between a loaded position wherein the spring member biases the hook towards engagement with the sector member and an unloaded position wherein the spring member biases the hook away from the sector member.

7. The hand-operated parking brake actuator according to claim 3, wherein movement of the pawl changes a force vector of the spring member to selectively bias the pawl in opposed directions relative to sector member.

8. The hand-operated parking brake actuator according to claim 7, wherein the pawl is rotatable about a connection pin extending through a slot in the pawl and the connection pin moves along the slot to change the force vector of the spring member.

9. The hand-operated parking brake actuator according to claim 3, wherein the spring member is a torsion spring.

10. The hand-operated parking brake actuator according to claim 3, wherein spring member directly acts between the pawl and the support bracket.

11. The hand-operated parking brake actuator according to claim 3, wherein the pawl is movable between an engaged and loaded position wherein the hook engages the sector member and the spring member biases the hook towards the sector member, an engaged and unloaded position wherein the hook engages at least one of the ratchet teeth and the spring member biases the hook away from the sector member, and a released and unloaded position wherein the hook is released from the sector member and the spring member biases the hook away from the sector member.

12. A hand-operated parking brake actuator comprising, in combination:
a support bracket;
a hand lever supported by the support bracket and pivotable between a brake-released position and a brake-applied position;
a pull-to-release lock mechanism operably connecting the hand lever to the support bracket;
wherein the lock mechanism includes a sector gear having a plurality of ratchet teeth, a pivotable pawl having a hook selectively engageable with the ratchet teeth to lock the lever in the brake-applied position, and a resilient spring member movable to selectively bias the pawl in opposed directions relative to sector member; and
wherein the pawl is movable between an engaged and loaded position wherein the hook engages the sector member and the spring member biases the hook towards the sector member, an engaged and unloaded position wherein the hook engages at least one of the ratchet teeth and the spring member biases the hook away from the sector member, and a released and unloaded position wherein the hook is released from the sector member and the spring member biases the hook away from the sector member.

13. The hand-operated parking brake actuator according to claim 12, wherein the pawl is in the engaged and loaded position when the hand lever is in the brake-released position, the pawl is moved to the engaged and unloaded position and the hand lever is locked against movement towards the brake-released position when the hand lever is pulled a first time towards the brake-applied position and released, and the pawl is moved to the released and unloaded position and the hand lever is free to move towards the brake-released position when the hand lever is in the brake released position and is pulled a second time towards the brake-applied position.

14. The hand-operated parking brake actuator according to claim 12, wherein the sector gear is rigidly secured to the hand lever and the pawl is rotatably secured to the support bracket.

15. The hand-operated parking brake actuator according to claim 12, wherein the pawl is rotatable about a connection pin extending through a slot in the pawl.

16. The hand-operated parking brake actuator according to claim 15, wherein the pawl is movable along the pin so that when the pin is located at a first end of the slot the spring member biases the hook towards engagement with the sector member and when the pin is located at a second end of the slot the spring member biases the hook away from the sector member.

17. The hand-operated parking brake actuator according to claim 12, wherein the pawl is rotatable about a connection pin extending through a slot in the pawl and the connection pin moves along the slot to change a force vector of the spring member so that when the pin is located at a first end of the slot the spring member biases the hook towards engagement with the sector member and when the pin is located at a second end of the slot the spring member biases the hook away from the sector member.

18. The hand-operated parking brake actuator according to claim 12, wherein the spring member is a torsion spring.

19. The hand-operated parking brake actuator according to claim 12, wherein spring member directly acts between the pawl and the support bracket.

20. A hand-operated parking brake actuator comprising, in combination:
a support bracket;
a hand lever supported by the support bracket and pivotable between a brake-released position and a brake-applied position;
a pull-to-release lock mechanism operably connecting the hand lever to the support bracket;
wherein the lock mechanism includes a sector gear having a plurality of ratchet teeth, a pivotable pawl having a hook selectively engageable with the ratchet teeth to lock the lever in the brake-applied position, and a torsion spring acting between the pawl and the support bracket and movable to selectively bias the pawl in opposed directions relative to sector member;
wherein the pawl is rotatable about a connection pin extending through a slot in the pawl;
wherein the pawl is movable between an engaged and loaded position wherein the hook engages the sector member and the spring member biases the hook towards the sector member, an engaged and unloaded position wherein the hook engages at least one of the ratchet teeth and the spring member biases the hook away from the sector member, and a released and unloaded position wherein the hook is released from the sector member and the spring member biases the hook away from the sector member; and
wherein the pawl is in the engaged and loaded position when the hand lever is in the brake-released position, the pawl is moved to the engaged and unloaded position and the hand lever is locked against movement towards the brake-released position when the hand lever is pulled a first time towards the brake-applied position and released, and the pawl is moved to the released and unloaded position and the hand lever is free to move towards the brake-released position when the hand lever is in the brake released position and is pulled a second time towards the brake-applied position.
